(19) United States
(12) Patent Application Publication
(10) Pub. No.: US 2007/0009118 A1
(43) Pub. Date: Jan. 11, 2007

(54) Boundary microphone

(75) Inventors: Mitsuo Kimura, Machida-shi (JP); Shinji Higashijima, Machida-shi (JP); Hiroyuki Ishida, Machida-shi (JP)

Correspondence Address: KANESAKA BERNER AND PARTNERS LLP, SUITE 300, 1700 DIAGONAL RD, ALEXANDRIA, VA, 22314-2848, US

(73) Assignee: KABUSHIKI KAISHA AUDIO-TECHNICA, Machida-shi (JP)

(21) Appl. No.: 11/480,484

(22) Filed: Jul. 5, 2006

(30) Foreign Application Priority Data
Jul. 6, 2005 (JP) 2005-197202

(51) Int. Cl. H04R 25/00

(52) U.S. Cl. 381/172

(57) ABSTRACT

An object of the present invention is to provide an on-surface sound pickup microphone that is made wireless by eliminating the need for a cable for connection to a receiver. An on-surface sound pickup microphone 1 includes a flat microphone case 10 including a base portion 20 that has a flat bottom surface and a porous sound pickup cover 23 that covers a top surface of the base portion 20. The microphone case contains a microphone unit and a sound signal output circuit for the microphone. In the on-surface sound pickup microphone 1 has a battery housing portion 220 in which a battery as a power source is housed, and a light emitting portion 230 serving as transmission means for the sound signal output circuit to radiate infrared rays emitted by the infrared light emitting element, to the outside of the microphone; the light emitting portion 230 consists of, for example, a diffusion lens.

### TECHNICAL FIELD

The present invention relates to an on-surface sound pickup microphone placed on a flat surface such as of a desk or floor, and more specifically, to a wireless on-surface sound pickup microphone that eliminates the need for a connection cable installed between the microphone and a receiver.

### BACKGROUND ART

If sound pickup is to be carried out in a meeting room or on the stage, sounds may not be clearly collected, owing to reflected sounds from the desk or floor surface, through, for example, goose neck microphones or microphones with long necks which are installed upright on a desk or floor surface. In a television broadcasting studio or on a podium in a lecture hall, the presence of microphones may offend the eye.

On-surface sound pickup microphones have been developed on the basis the principle that the adverse effect of reflected sounds is reduced by placing the microphone unit closer to a reflection surface. A conventional example of an on-surface sound pickup microphone is described in Japanese Patent Application Publication No. 2005-167480.

The on-surface sound pickup microphone is also called a boundary microphone or surface mount microphone and comprises a flat microphone case shaped like a turtle. The on-surface sound pickup microphone is likely to be out of sight and is unnoticeable. Consequently, the on-surface sound pickup microphone is preferably employed in a television broadcasting studio, meeting room, or lecture hall.

However, the conventional on-surface sound pickup microphone is connected to a microphone amplifier and the like via a cable as described in Japanese Patent Application Publication No. 2005-167480. Accordingly, the microphone itself is unnoticeable but is an eyesore if the cable is disorderly installed.

Particularly on the stage, where stage crew and actors continually move about, they may be lost their balances on cables. Further, an overriding problem is a cumbersome operation of installing a cable every time a new microphone is installed.

An object of the present invention is provide an on-surface sound pickup microphone comprising a microphone case made flat so that a microphone unit can be located as close to a reflection surface of a desk, a floor, or the like as possible, the microphone unit being housed in the microphone case, wherein the microphone is made wireless by eliminating the need for a cable for connection to a microphone amplifier and the like.

### SUMMARY OF THE INVENTION

To accomplish the above object, the present invention provides an on-surface sound pickup microphone comprising a flat microphone case including a base portion that has a flat bottom surface and a porous sound pickup cover that covers a top surface of the base portion, the microphone case containing a microphone unit and a sound signal output circuit for the microphone unit, the microphone being characterized in that the microphone operates using a battery as a power supply and in that an infrared light emitting element is used as a transmission means for the sound signal output circuit.

Thus, the power supply for the on-surface sound pickup microphone comprises batteries, and the infrared light emitting element is used as a transmission means for the sound signal output circuit. For example, this eliminates the need for a balancing shield cable that is required when the microphone is operated using a phantom power supply. The microphone can be thus wireless. Therefore, when installed, the microphone has only to be placed on a desk or floor surface. This eliminates the need for a cumbersome operation of installing a cable. Further, the microphone is no longer an eyesore on the state. Stage crew and actors are prevented from losing their balances on the cable. Moreover, the use of infrared rays instead of electric waves makes it possible to avoid possible eavesdropping or electrical interference.

The microphone is also characterized in that a light emitting portion is provided in a predetermined area of a top surface of the sound pickup cover to direct infrared rays emitted by the infrared light emitting element, to an outside of the microphone.

This enables infrared rays to be radiated over a wide range toward the ceiling.

The microphone is also characterized in that a plurality of the infrared light emitting elements are arranged in a projection area of the light emitting portion on the base portion so as to have optical axes extending in different directions.

This further increases the range of infrared radiation. The on-surface sound pickup microphone can be installed with no regard for the presence of an indoor obstacle such as a pillar.

The microphone is also characterized in that the light emitting portion comprises a diffusion lens. This enables infrared rays to be radiated over a winder range toward the ceiling.

The microphone is also characterized in that a mute switch is further provided in a predetermined area of the top surface of the sound pickup cover to attenuate an output from the sound signal output circuit. This enables the mute switch to be easily and quickly operated when muting is required.

The microphone is also characterized in that the battery is a secondary battery and in that a charging terminal is provided in a predetermined area of the base portion to connect the secondary battery to a charger. This enables the battery to be charged as required during an intermission of a meeting or a performance. The battery is also prevented from being disadvantageously exhausted during the meeting or performance.

### BRIEF DESCRIPTION OF THE DRAWINGS

FIG. 1 is a perspective view of appearance of an on-surface sound pickup microphone of the present invention as viewed from its front;

FIG. 2 is a perspective view of front appearance of the on-surface sound pickup microphone as viewed from a different angle;

FIG. 3 is a perspective view of the on-surface sound pickup microphone with its sound pickup cover removed to show its internal structure;

FIG. 4 is a right side view of FIG. 3;

FIG. 5A is a circuit diagram of a sound output side;

FIG. 5B is a circuit diagram of a light receiver side;

FIG. 6 is a schematic diagram showing an example in which the on-surface sound pickup microphone is used in a meeting room;

FIG. 7 is a schematic diagram showing an example in which the on-surface sound pickup microphone is used on the stage; and

FIG. 8 is a perspective view showing how the on-surface sound pickup microphone is charged.

### DETAILED DESCRIPTION

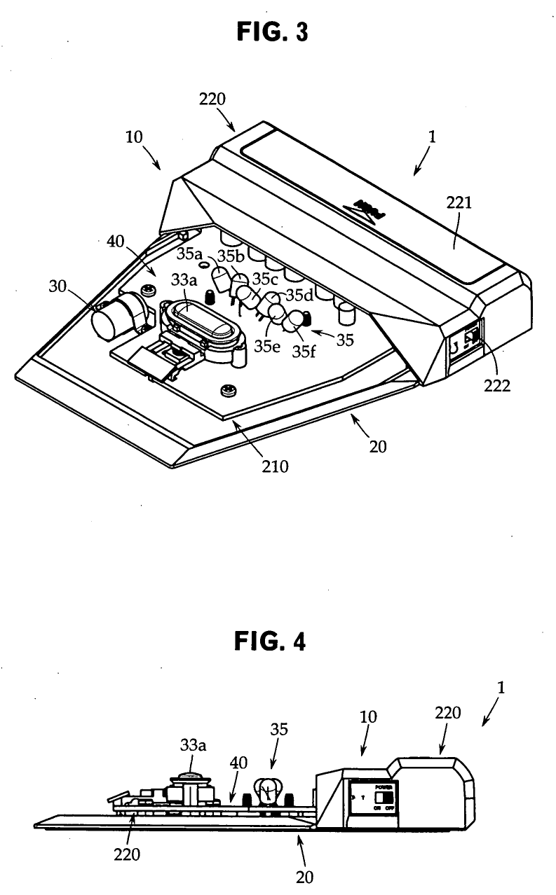

Now, an embodiment of the present invention will be described with reference to the drawings. However, the present invention is not limited to this embodiment. FIGS. I and 2 are perspective views of front appearance of an on-surface sound pickup microphone of the present invention as viewed from different angles. FIG. 3 is a perspective view of the on-surface sound pickup microphone with its sound pickup cover removed to show its internal structure. FIG. 4 is a right side view of FIG. 3.

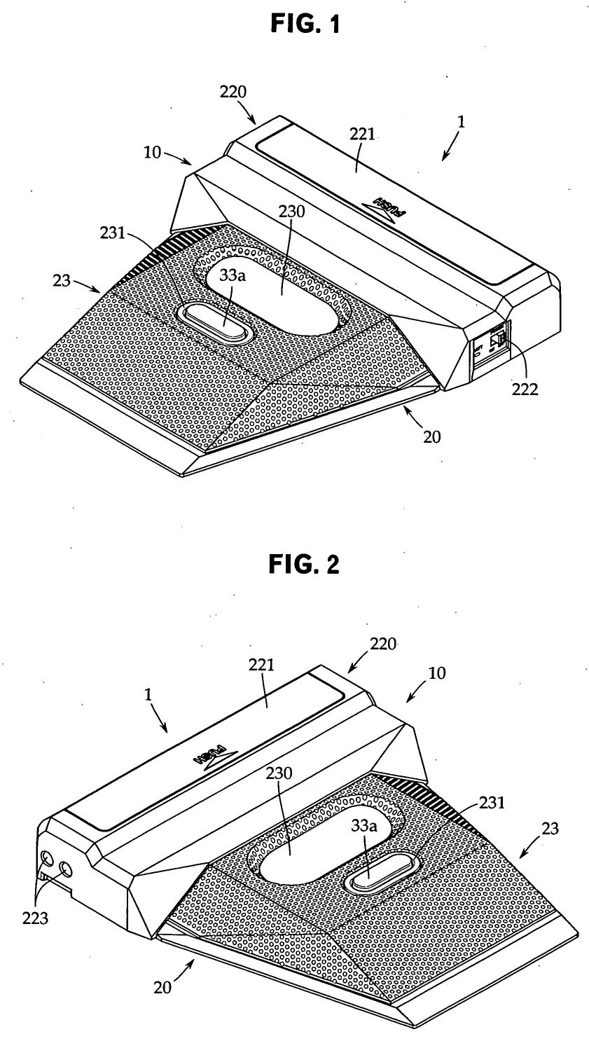

As shown in FIGS. 1 and 2, an on-surface sound pickup microphone 1 comprises a microphone case 10 having a generally flat shape. The microphone case 10 includes a base portion 20 and a sound pickup cover 23 that covers a top surface of the base portion 20.

The base portion 20 is preferably composed of a metal material such as a zinc die cast in order to more appropriately shield external electromagnetic waves. A bottom surface of the base portion 20 is finished flat so that the microphone can be stably installed on a desk or floor surface. As shown in FIGS. 3 and 4, the base portion 20 comprises a planar parts placement portion 210 having a battery housing portion 220 integrally placed at one end.

Main parts provided on the parts placement portion 210 include a microphone unit 30 and a circuit board 40. In the on-surface sound pickup microphone, the microphone unit 30 is usually a capacitor microphone unit but may be of another type. The directionality of the microphone unit 30 is arbitrarily selected; the microphone unit 30 may have non-directionality or unidirectionality.

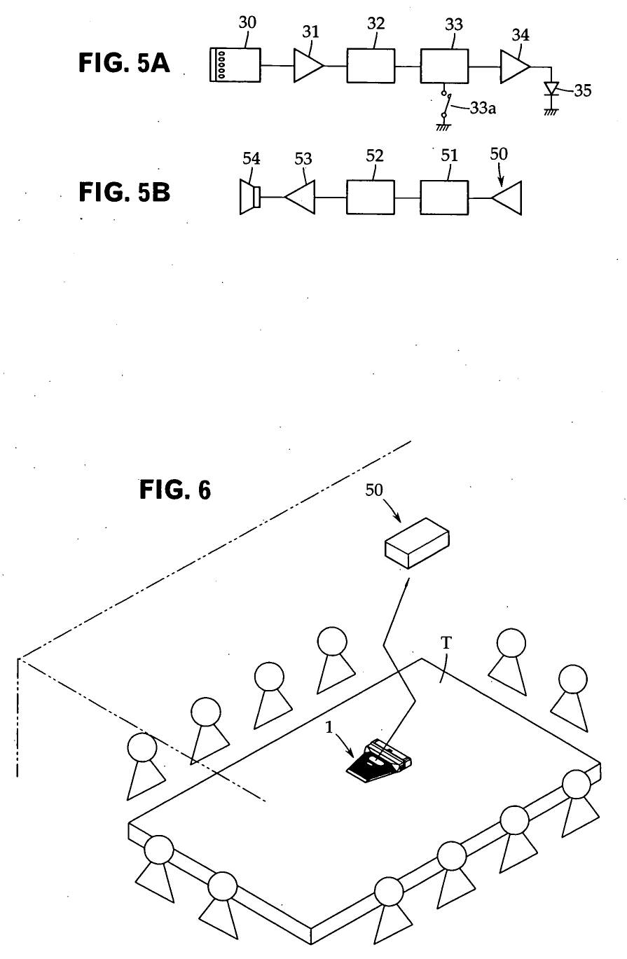

A sound signal output circuit is mounted on the circuit board 40; the sound signal output circuit is connected to the microphone unit 30. In this embodiment, the sound signal output circuit comprises an initial amplifier 3 1 that amplifies a microphone signal from the microphone unit 30, a modulator 32 that subjects the amplified microphone signal to, for example, FM modulation, a mute circuit 33 including a mute switch 33a, and a driving amplifier 34 that drives transmission means, and an infrared light emitting element 35 serving as the transmission means as shown in FIG. 5A. In FIGS. 3 and 4, for the convenience of the drawings, only the mute switch 33a and infrared light emitting element 35 are shown as parts mounted on the circuit board 40.

In this example, the infrared light emitting element 35 includes six infrared light emitting diodes 35a to 35f. When mounted on the circuit board 40, the infrared light emitting diodes 35a to 35f have optical axes slightly offset from one another so that infrared rays are evenly radiated in all directions.

The battery housing portion 220 houses a battery (not shown) used as a power source for the microphone 1. The battery may be a primary one but this embodiment uses a chargeable secondary battery. The battery housing portion 220 comprises a battery cover 221 through which the battery is taken in and out.The internal structure of the battery housing portion 220 is not shown but a known structure having a positive and negative terminal may be employed.

A power switch 222 is provided on one side of the battery housing portion 220 as shown in FIG. 1. A pair of charging terminals 223 for a secondary battery is provided on the other side of the battery housing portion 220 as shown in FIG. 2.

The sound pickup cover 23 is detachably attached to the base portion 20 via screws (not shown) so as to cover a top surface of the parts placement portion 210. The sound pickup cover 23 consists of a porous metal material so as to shield external electromagnetic waves. In this example, a punching metal is used but a mesh metal may be used.

As shown in FIGS. 1 and 2, in this example, the sound pickup cover 23 is designed to have a three-dimensional trapezoidal shape matching the battery housing portion 220. An opening 231 is formed in a top surface of the sound pickup cover 23 so as to expose the mute switch 33a when the sound pickup cover 23 is installed.

A light emitting portion 230 is formed in the top surface of the sound pickup cover 23 to radiate infrared rays emitted by the infrared light emitting element 35, to the outside of the microphone. The light emitting portion 230 visually serves as an infrared transmission portion. The light emitting portion 230 may be a transparent member that produces no lens effect. However, in the preferred aspect of this example, the light emitting portion 230 is composed of a diffusion lens to radiate infrared rays over a wider range.

To efficiently radiate infrared rays emitted by the infrared light emitting element 35, to the outside of the microphone, the six infrared light emitting diodes 35a to 35f, included in the infrared light emitting element 35, are preferably arranged within a projection area of the light emitting portion (diffusion lens) 230, that is, the range covered by the light emitting portion (diffusion lens) in a plan view.

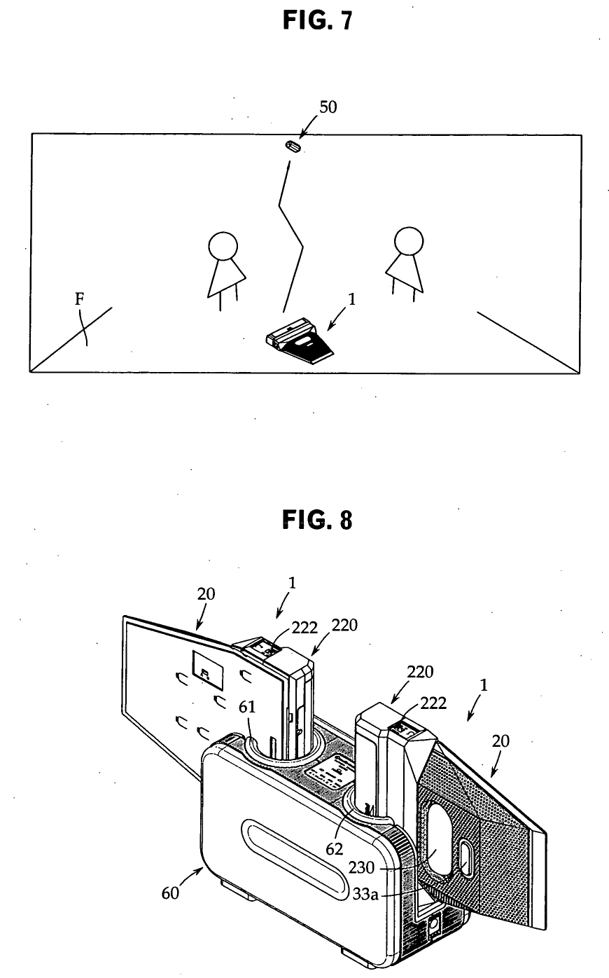

By way of example, in a meeting room, the on-surface sound pickup microphone 1 is placed on a table T as shown in FIG. 6. On the stage, the on-surface sound pickup microphone 1 is placed on a floor F as shown in FIG. 7. The on-surface sound pickup microphone 1 has no transmission cable and thus has only to be placed on the table T or floor F before use.

This eliminates the need for a cumbersome operation of routing a cable. The microphone is no longer an eyesore on the stage. Stage crew and actors are prevented from losing their balances on the cable. Moreover, the use of infrared rays instead of electric waves makes it possible to avoid possible eavesdropping or electrical interference.

With the on-surface sound pickup microphone 1, an infrared signal is radiated from the light emitting portion (diffusion lens) 230, located on the top surface of the sound pickup cover 30, toward the ceiling and wall surface in the room. Accordingly, the infrared light receiver 50 is preferably installed on the ceiling or in a corner of the room so as not to be an obstacle.

The infrared signal received by the infrared light receiver 50 is predeterminedly amplified by an amplifier 51 and then demodulated by a demodulator 52 as shown in FIG. 5B. Then, in this example, the demodulated signal is provided to a driving amplifier 53 for a speaker 54. This allows sounds picked up by the on-surface sound pickup microphone 1 to be amplified and emitted by the speaker 54. The sounds may then be recorded by a recorder.

Further, in the on-surface sound pickup microphone 1, the mute switch 33a is provided on the top surface of the sound pickup cover 30, where the mute switch 33a can be easily operated. This enables the mute circuit 33 to be easily and quickly operated when muting is required.

The on-surface sound pickup microphone 1 also comprises the charging terminals 223. This enables the secondary battery to be charged as required during an intermission of a meeting or a performance. The battery is also prevented from being disadvantageously exhausted during the meeting or performance. FIG. 8 shows that the on-surface sound pickup microphone 1 is being charged using a dedicated charger 60.

The charger 60 has, for example, two charging portions 61 and 62 into each of which the charging terminal 223 side of the battery housing portion 220 is inserted in a vertical direction. A connector (not shown) for the charging terminal 223 is provided at the bottom of each of the charging portions 61 and 62. Accordingly, the charger 60 can simultaneously charge the two upright on-surface sound pickup microphones 1.

As described above, the on-surface sound pickup microphone of the present invention has the infrared transmission portion and is wireless. For example, in a meeting room, the microphone is simply placed on a table, thus eliminating the need for a cable, which may be an obstacle. In preparation for a meeting, it is unnecessary to route cables. Moreover, on the stage, stage crew and actors are prevented from losing their balances on cables and the microphone is no longer an eyesore.

The present application is based on, and claims priority from, Japanese Application Serial Number JP2005-197202, filed Jul. 6, 2005, the disclosure of which is hereby incorporated by reference herein in its entirety.

1. A wireless on-surface sound pickup microphone comprising a flat microphone case including a base portion that has a flat bottom surface and a porous sound pickup cover that covers a top surface of the base portion, the microphone case containing a microphone unit and a sound signal output circuit for the microphone,
wherein the microphone operates using a battery as a power supply and an infrared light emitting element is used as a transmission means for the sound signal output circuit.

2. The on-surface sound pickup microphone according to claim 1, wherein a light emitting portion is provided in a predetermined area of a top surface of the sound pickup cover to direct infrared rays emitted by the infrared light emitting element, to an outside of the microphone.

3. The on-surface sound pickup microphone according to claim 2, wherein a plurality of the infrared light emitting elements are arranged in a projection area of the light emitting portion on the base portion so as to have optical axes extending in different directions.

4. The on-surface sound pickup microphone according to claim 2 wherein the light emitting portion comprises a diffusion lens.

5. The on-surface sound pickup microphone according to claim 1, wherein a mute switch is further provided in a predetermined area of the top surface of the sound pickup cover to attenuate an output from the sound signal output circuit.

6. The on-surface sound pickup microphone according to claim 1, wherein the battery is a secondary battery and a charging terminal is provided in a predetermined area of the base portion to connect the secondary battery to a charger.
